(19) United States
(12) Patent Application Publication
(10) Pub. No.: US 2024/0239011 A1
(43) Pub. Date: Jul. 18, 2024

(54) COLORANT SET FOR CERAMIC DENTURES WITH ADJUSTABLE LIGHT TRANSMITTANCE AND COLOR AND THREE-DIMENSIONAL LAMINATION APPARATUS USING THE SET

(71) Applicant: FRANZ COLLECTION INC., Taipei City (TW)

(72) Inventors: Feng-Ming YEN, Taipei City (TW); Li-Heng CHENG, Taipei City (TW)

(21) Appl. No.: 18/407,520

(22) Filed: Jan. 9, 2024

(30) Foreign Application Priority Data
Jan. 18, 2023 (TW) 112102220

(51) Int. Cl. B28B 17/00; B28B 1/00; C04B 35/48; C04B 35/626

(52) U.S. Cl. CPC B28B 17/0081; B28B 1/001; C04B 35/48; C04B 35/6269; C04B 2235/3217; C04B 2235/3225; C04B 2235/3246; C04B 2235/443; C04B 2235/444; C04B 2235/449; C04B 2235/6026; C04B 2235/9661

(57) ABSTRACT

The present invention relates to a colorant set which comprises a first colorant composed of a warm color solution, a second colorant composed of a cold color solution, and a third colorant composed of a light-transmitting solution, or the colorant set only comprises the first and second colorants, and the light-transmitting solution can be added directly into the first or second colorant. The warm color solution contains 0.1 wt % to 5 wt % of water-soluble iron salt and water; the cold color solution contains 0.01 wt % to 2 wt % of water-soluble cobalt salt and water; the light-transmitting solution contains 10 wt % to 50 wt % of water-soluble yttrium or lanthanum salt and water. Accordingly, during a three-dimensional lamination molding process, the light transmittance is adjusted while spraying and coloring are performed on each layer, thereby obtaining a ceramic denture with quite natural color and light transmittance.

### FIELD OF THE INVENTION

The present invention relates to a colorant set for a ceramic denture with adjustable light transmittance and color and a three-dimensional lamination apparatus using the set, and especially to an apparatus capable of coloring and increasing light transmittance simultaneously during the molding process of three-dimensional laminated ceramic dentures and the colorant formulas thereof.

### DESCRIPTION OF THE PRIOR ART

The three-dimensional lamination technology has the advantages of customizable production and completely unlimited molding shape, and has gradually played an important role in the field of ceramic denture manufacturing. However, there are few existing technologies that can directly perform coloring and adjust light transmittance simultaneously during a molding process. At present, the coloring of manufacturing ceramic dentures using the three-dimensional lamination technology is mainly performed by hand, that is, the dental technician colors completely laminated dentures in person. However, to perform coloring by hand is time-consuming, labor-intensive, expensive in labor cost, and significantly relies on the experience and ability of the dental technician.

In order to resolve the coloring problem of ceramic dentures manufactured by the three-dimensional lamination technology, the applicant has successively filed several patent applications, such as Taiwan Patent Publication No. 202222274, entitled “Three-Dimensional Lamination and Coloring Equipment for Ceramic Dental Crown and Method Thereof”, which disclosed that in a slurry-laying process, colorant is sprayed on slurry layer by layer, so natural gradation of color can be presented. However, for example, the presentation of a multi-color system such as cold or warm colors for anterior teeth or posterior teeth has not been considered much, and changes in light transmittance cannot be made.

In addition, in order to resolve the problem of light transmittance, please refer to the Taiwan patent application Ser. No. 110148100, entitled “Apparatus and Method for Three-Dimensionally Laminating a Ceramic Denture in a Color-and-Transmittance Variable Manner”, in which two kinds of slurries with different components are used. These two slurries contain different proportions of yttrium oxide, and by changing the ratio of the two slurries during the lamination process, different degrees of light transmittance can be formed. However, in this method, the color matching and light transmittance of each layer are fixed during the lamination process, and it is impossible to present different colors or light transmittance for different areas in the same layer, so it is suitable for the production of the same type of dentures, such as batch production of anterior or posterior teeth, and it is difficult to adjust different formulas for different dentures in the same production batch immediately.

It can be seen from the above that a colorant set for a ceramic denture which is suitable for customized production and can be used for performing coloring and light transmittance adjustment simultaneously and a ceramic denture-manufacturing apparatus which can automatically form ceramic dental crowns and automatically perform coloring by using this set are really what the industry and the general public are eagerly looking forward to.

### SUMMARY OF THE INVENTION

The main objective of the present invention is that in the three-dimensional lamination molding process, coloring and light transmittance adjustment are performed simultaneously; the overall color and light transmittance look quite natural, almost the same as those of natural teeth; color comparison and coloring operation after dental crown molding in the traditional manufacturing process can be eliminated or greatly reduced to realize automatic production without affecting hardness and service life; it is quite easy to control coloring and even to be able to produce various personalized patterns.

In order to achieve the above objective, the present invention provides a colorant set for a ceramic denture with adjustable light transmittance and color, wherein the colorant set mainly comprises: a first colorant, including a warm color solution; and a second colorant, including a cold color solution, wherein the colorant set for a ceramic denture further includes a light-transmitting solution in at least one of the following aspects (i)-(iii): (i) the light-transmitting solution is added in the first colorant with the warm color solution: the light-transmitting solution=1:0.1 to 1:1; (ii) the light-transmitting solution is added in the second colorant with the cold color solution: the light-transmitting solution=1:1 to 1:2; and (iii) the light-transmitting solution is a component of a third colorant, wherein the warm color solution contains 0.1 wt % to 5 wt % of water-soluble iron salt and water; the cold color solution contains 0.01 wt % to 2 wt % of water-soluble cobalt salt and water; the light-transmitting solution contains 10 wt % to 50 wt % of water-soluble yttrium or lanthanum salt and water.

In other words, the colorant set for a ceramic denture with adjustable light transmittance and color according to the present invention provides all the elements that can present natural tooth colors, such as the warm color system that appears more at the neck of the tooth and the cool color system that appears more at the incisal edge of the tooth. Importantly, the light-transmitting solution further enables ceramic dentures to exhibit varying degrees of light transmittance, specifically to be almost the same as natural teeth.

Moreover, in order to achieve the above objective, the present invention further provides a three-dimensional lamination apparatus, which mainly comprises a slurry-laying module, a colorant-spraying module, a photocuring module and a main controller, wherein the slurry-laying module includes a slurry tank, in which a slurry is stored; the colorant-spraying module includes the above-mentioned colorant set for a ceramic denture; the main controller is electrically connected to the slurry-laying module, the colorant-spraying module and the photocuring module, and the main controller includes a memory module, in which a plurality of laminated graphic files and a plurality of coloring parameter files are stored. The plurality of laminated graphic files are obtained by slicing a three-dimensional image of a dental crown to be formed in a specific direction at a specific thickness, and the plurality of coloring parameter files correspond to the plurality of laminated graphic files. The main controller controls the slurry-laying module to lay a slurry layer on a substrate with the slurry in the slurry tank; the main controller controls the colorant-spraying module according to the plurality of coloring parameter files to spray the colorants on the slurry layer with the colorant set for a ceramic denture; the main controller controls the photocuring module to photocure the slurry layer according to the plurality of laminated graphic files.

It is further illustrated that the three-dimensional lamination apparatus of the present invention uses the slurry-laying module to lay the slurry layer; then performs spraying and coloring on the slurry layer, wherein the colorants used can present the cold color system, the warm color system and light transmittance; and the slurry layer is phtocured to form a predetermined shape after coloring. Accordingly, the present invention can color each slurry layer, and can also change the coloring effect of each colorant layer at any time, so the overall coloring effect of the dental crown looks quite natural, the light transmittance is good, the color is quite saturated, and there will be no blooming between colorant layers, and even any fine pattern can be painted.

In addition, the three-dimensional lamination apparatus of the present invention can further comprise an airflow-generating device and a heating device, which are electrically connected to the main controller, wherein the substrate can be composed of a material or structure with a water absorption rate of 5% or more; the main controller can control the airflow-generating device to blow air to the lower surface of the substrate or draw air from the lower surface of the substrate; and the main controller can also control the heating device to heat the slurry layer. Accordingly, the airflow-generating device can help removal of moisture in the substrate to make it dry quickly, and the substrate with high water absorption rate and the heating device can further accelerate the drying of the slurry layers and the colorants, thereby effectively improving the process efficiency.

### BRIEF DESCRIPTION OF DRAWINGS

FIG. 1 is a system architecture diagram according to a first embodiment of the present invention.

FIG. 2 is an apparatus schematic diagram according to the first embodiment of the present invention.

FIG. 3 is a system architecture diagram according to a second embodiment of the present invention.

### DETAILED DESCRIPTION OF THE INVENTION

Before a colorant set for a ceramic denture with adjustable light transmittance and color and a three-dimensional lamination apparatus using the set of the present invention are described in detail, it should be noted that in the following description, similar components will be designated by the same reference numerals. Furthermore, the drawings of the present invention are for illustrative purpose only and are not necessarily drawn to scale, and not all details are necessarily presented in the drawings.

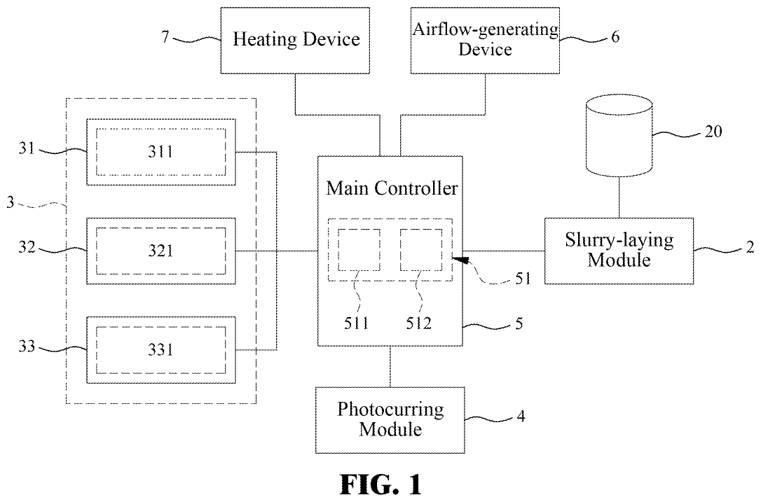

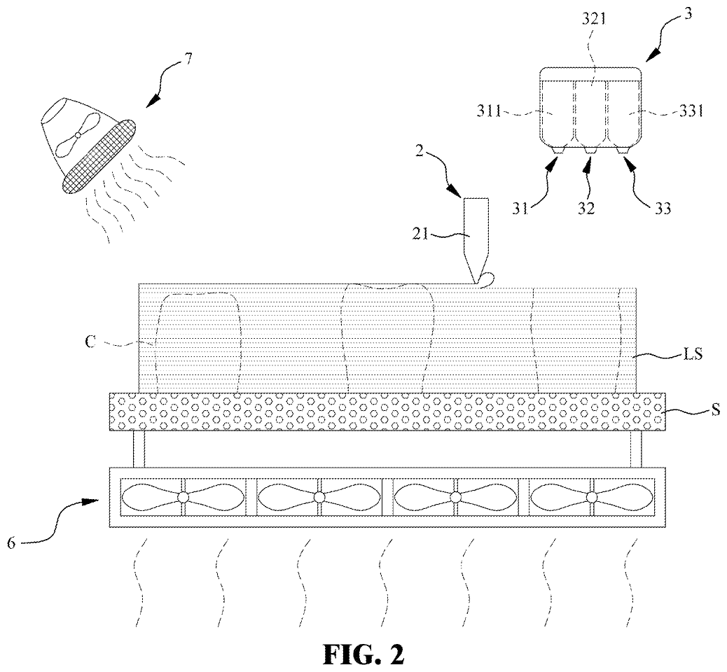

Please refer to FIG. 1 and FIG. 2 at the same time. FIG. 1 is a system architecture diagram according to a first embodiment of a three-dimensional lamination apparatus of the present invention, and FIG. 2 is an apparatus schematic diagram according to the first embodiment of the three-dimensional lamination apparatus of the present invention. As shown in the figure, the three-dimensional lamination apparatus of this embodiment mainly comprises a slurry-laying module 2, a colorant-spraying module 3, a photocuring module 4, a main controller 5, an airflow-generating device 6, and a heating device 7, wherein the main controller 5 is electrically connected to the rest modules and devices and controls their operations.

It is further illustrated that the slurry-laying module 2 includes a slurry tank 20, in which a slurry is stored, and the slurry is mainly composed of 100 parts by weight of ceramic powder, 12-18 parts by weight of photocurable resin, 2-4 parts by weight of plasticizer, 0.5-5 parts by weight of dispersant, and 10-20 parts by weight of a solvent.

Among them, the ceramic powder includes more than 99.7% mixed powder containing zirconium oxide powder and yttrium oxide powder, less than 0.1% aluminum oxide powder, and less than 0.05% base color colorant, and the content of the yttrium oxide powder in the mixed powder can be 2-6 mole %.

yttrium oxide in the ceramic mixed powder is used to stabilize zirconium oxide. The higher the content of the yttrium oxide powder, the higher the light transmittance. The higher light transmittance is suitable for those who have high aesthetic requirements, but the relative strength will be weakened. With a content of 3 mole %, the bending strength can reach 1400 MPa, but the light transmittance is only 35%, so it is suitable for preparing dental bridges or posterior teeth; on the contrary, with a content of 5 mole %, the bending strength only reaches 600 MPa, but the light transmittance can reach 49%, so it is suitable for preparing anterior teeth or dental veneers.

In addition, the base color colorant can contain at least one of iron, chromium, titanium, manganese, cobalt, nickel, copper, vanadium, and rare earth elements; the base color colorant can be formulated according to the actual tooth color of the patient to present base color. The photocurable resin includes at least one of water-soluble resin and water-dispersible resin. In the present embodiment, the photocurable resin is mainly composed of 52-57 wt % of acrylate monomers, 40-42 wt % of acrylate oligomers, 1-4 wt % of photoinitiator, and 0˜2 wt % of additive, wherein the additive can be selected and added, depending on the actual situation, but is not absolutely necessary.

The plasticizer can contain at least one of polyethylene glycol with molecular weight of 150 to 450 (such as PEG#200, PEG#400) and glycerin. The plasticizer is mainly used to reduce the glass transition temperature of a binder so that the binder has better flexibility at room temperature. The dispersant can be an organic acid, such as at least one of polycarboxylate, polymer ammonium salt (such as ammonium polyacrylate), and polymer sodium salt (such as sodium polyacrylate).

Moreover, the solvent of the present embodiment can be 100% water or a mixed solvent of water and alcohol, such as water and at least one of ethanol (ET), isopropanol (IPA), propylene glycol (PG), and hexamethylene glycol (HG), wherein the water is preferably deionized water. In addition, a binder can be added to the slurry and can contain at least one of polyethylene glycol with molecular weight of 1500 to 8000 (such as PEG#2000, PEG#4000, PEG#6000), polyvinyl alcohol, and polyethylene oxide. The binder can improve the strength of a dried ceramic green body, and can resist the shear force generated when laying the slurry, and can adjust viscosity to prevent the particles from settling.

The slurry-laying module 2 further includes a feeder (not shown in the figure) and a scraper 21. The cross section of the feeder is roughly funnel-shaped, and the feeder can evenly lay strips of slurry on a substrate S. Furthermore, the scraper 21 can flatly scrape the strips of slurry laid by the feeder.

Furthermore, the colorant-spraying module 3 of the present embodiment includes a first spraying unit 31, a second spraying unit 32, a third spraying unit 33 and a colorant set for a ceramic denture, which includes a first colorant 311, a second colorant 321, and a third colorant 331. The first colorant 311 is a warm color solution, is arranged in the first spraying unit 31, and can allow dentures to present coffee color to coffee grey color. The first colorant 311 can contain 0.1 wt % to 5 wt % (2 wt % in the present embodiment) of water-soluble iron salt and water, and the water-soluble iron salt includes at least one of ferric nitrate, ferrous chloride, and ferric acetate.

The second colorant 321 is arranged in the second spraying unit 32, and includes a cold color solution containing 0.01 wt % to 2 wt % of water-soluble cobalt salt and water, an aluminous solution containing 0.1 wt % to 10 wt % of water-soluble aluminum salt and water, and a calcareous solution containing 0.1 wt % to 10 wt % of water-soluble calcium salt and water, which are mixed together. The volume ratio of these solutions is 1:1:1. More specifically, in the present embodiment, the cold color solution contains 0.2 wt % of water-soluble cobalt salt, the aluminous solution contains 2 wt % of water-soluble aluminum salt, and the calcareous solution contains 2 wt % of water-soluble calcium salt.

Among them, the water-soluble cobalt salt is a main colorant, and can include at least one of cobaltic nitrate, cobaltous chloride, and cobaltic acetate, only a small amount of which can produce bright color tones, and can make dentures present blue grey with purple to pure blue grey. Since the inside of the mouth is red, there is a choice of posterior teeth with purple, especially at the incisal edges of the teeth. The aluminous solution and the cold color solution can provide blue-grey tone together, and the aluminous solution can contain at least one of aluminum nitrate, aluminum chloride, and aluminum acetate, but excessive aluminous solution will increase whiteness and reduce transparency at the same time, so can covers darker teeth. Adding a small amount of calcareous solution can increase transparency; adding a large amount of calcareous solution can increase whiteness while reducing transparency, and can also cover darker teeth. The calcareous solution can contain at least one of calcium nitrate, calcium chloride, and calcium acetate.

Furthermore, the third colorant 331 is a light-transmitting solution, can increase light transmittance and compensate light transmittance decreased by the color enhancement of the warm color solution and the cold color solution, and is arranged in the third spraying unit 33. The light-transmitting solution can contain 10 wt % to 50 wt % (20 wt %, in the present embodiment)of water-soluble rare earth (such as yttrium or lanthanum) salt and water. It is further illustrated that the water-soluble rare earth salt can be for example yttrium nitrate, yttrium chloride, yttrium acetate, lanthanum nitrate, lanthanum chloride, or lanthanum acetate, and is mainly used to reduce factors that hinder transparency (such as to form glass phase or to reduce defects), or to stabilize the cubic phase in the zirconia crystal phase, thereby reducing light reflection and scattering in the material and increasing transparency. Moreover, in other embodiments, in addition to water, some ethanol can also be added into the solvent of the first colorant 311, the second colorant 321 and the third colorant 331 to speed up the volatilization rate of the colorants after spraying.

Furthermore, the photocuring module 4 of this embodiment is a digital light processing (DLP) UV light machine, which can project UV light on the slurry according to the laminated graphic file, so that the slurry is cured layer by layer. In addition, it is worth mentioning that the substrate S in this embodiment is composed of a material or structure with a water absorption rate of 5% or more, such as a diatomaceous earth or ceramic plate with a porous structure. Therefore, when the slurry is laid and formed on the substrate S, the substrate S can absorb the moisture in the slurry immediately and rapidly, thereby greatly reducing the volatilization time of the moisture in the slurry and improving production efficiency.

Moreover, the main controller 5 of the present embodiment is electrically connected to the slurry-laying module 2, the colorant-spraying module 3, the photocuring module 4, the airflow-generating device 6 and the heating device 7, and the main controller 5 includes a memory module 51, in which a plurality of laminated graphic files 511 and a plurality of coloring parameter files 512 are stored. The plurality of laminated graphic files 511 are obtained by slicing a three-dimensional image of a dental crown C to be formed in a specific direction at a specific thickness, wherein the specific thickness is the laying thickness of the slurry. The plurality of coloring parameter files 512 correspond to the plurality of laminated graphic files 511.

It is further illustrated that each laminated graphic file 511 comprises a cross-sectional graphic produced by slicing a three-dimensional image of a dental crown C to be formed layer by layer at a specific thickness along a horizontal direction. That is to say, a three-dimensional image of a ceramic dental crown to be formed is first sliced layer by layer by means of an image processing unit according to a specific thickness of reactive layers (the laying thickness of the slurry) in a subsequent process so as to obtain the plurality of laminated graphic files 511, and the plurality of laminated graphic files 511 can be sequentially used in subsequent layer-by-layer projection curing process steps for shaping the ceramic dental crown. The three-dimensional image data can be obtained through an optical 3D scanning system or through a CAD drawing.

On the other hand, the plurality of coloring parameter files 512 basically correspond to the plurality of laminated graphic files 511, that is, each laminated graphic file 511 corresponds to a coloring parameter file 512, which records the spraying position and the spraying amounts of the warm color solution, the cold color solution, and the light-transmitting solution. The coloring parameter files 512 of the present embodiment are obtained according to the results obtained by analyzing and appropriately processing the image of the patient's original tooth or neighboring tooth.

The manufacturing process of the present embodiment is described in the following. First, the main controller 5 controls the slurry-laying module 2 to lay the slurry in the slurry tank 20 evenly on the substrate S to form a slurry layer LS. It will take a few second waiting time to allow the substrate S to absorb part of the moisture in the slurry layer LS so that the slurry layer LS is roughly dried and shaped. Next, the main controller 5 controls the colorant-spraying module 3 to color the slurry layer LS with the first colorant 311, the second colorant 321, and the third colorant 331 according to a corresponding coloring parameter file 512 to form a colorant layer. In this step, if the specific thickness of the sliced layer is thicker, it will take a few second waiting time to allow the colorants to gradually penetrate into the slurry layer LS, so that the slurry layer LS is colored uniformly; otherwise, if the specific thickness of the sliced layer is thinner, no waiting step is required.

Furthermore, the main controller 5 controls the photocuring module 4 to project UV light on the slurry layer LS according to a corresponding laminated graphic file 511 so as to cure and shape the area to be formed. By analogy, it is only necessary to repeat the step of laying the slurry layer LS, the step of coloring the slurry layer LS with the colorants, and the step of photocuring until a ceramic dental crown green body is completed.

Since generally a natural tooth mainly presents a warm color, and changes to a cold color only at the incisal edge; and its light transmittance graduates from the low light transmittance at the neck of the tooth to the high light transmittance at the incisal edge. Therefore, when a denture is laminated from the neck to the incisal edge in this embodiment, the amount of the first colorant 311 sprayed by the colorant-spraying module 3 is relatively large on the neck, and is gradually decreased toward the incisal edge to be gradually formed. On the contrary, the amounts of the second colorant 321 and the third colorant 331 sprayed by the colorant-spraying module 3 are relatively small on the neck, and are gradually increased toward the incisal edge to be gradually formed. Even on the neck, there is no second colorant 321 sprayed, and there is only a small amount of the third colorant 331 sprayed. In this way, the ceramic denture with natural colors and light transmittance can be prepared, and the coloring can be customized according to various actual situations.

Finally, after removing the uncured slurry, the ceramic dental crown green body is sintered at high temperature to form a ceramic dental crown, that is, the ceramic is sintered at a high temperature of 1100° C.-1700° C. (the temperature is generally 1100° C.-1300° C. when using glass ceramics; 1300° C.-1600° C. when using zirconia; 1300° C.-1700° C. when using aluminum oxide) to form a ceramic dental crown having a smooth and flat surface and well colored.

In particular, as shown in FIG. 1 and FIG. 2, the airflow- generating device 6 is arranged below the substrate S in the present embodiment, and can blow air toward the lower surface of the substrate S or draw air from the lower surface of the substrate S, thereby improving the moisture removal efficiency of the substrate S and effectively maintaining the water absorption of the substrate S. Moreover, the heating device 7 is arranged above the substrate S in the present embodiment, and can be used to dry the laid slurry layers LS and the colorants, thereby greatly shortening the waiting times after slurry laying and colorant spraying and significantly improving the process efficiency.

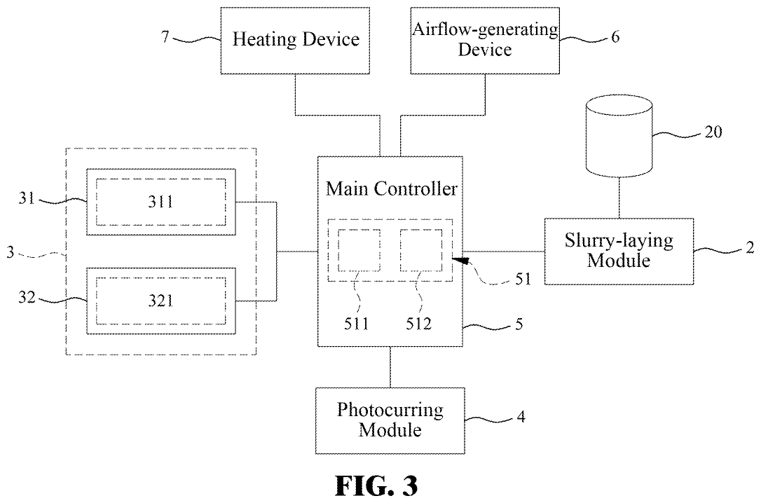

Please refer to FIG. 3, which is a system architecture diagram according to a second embodiment of the three-dimensional lamination apparatus of the present invention. The main difference between this embodiment and the aforementioned first embodiment is that this embodiment only uses two kinds of colorants with a warm color and a cold color, and the light-transmitting colorant is mixed with the two kinds of colorants. However, regarding the way to mix the light-transmitting colorant, it can be performed roughly according to the following situations.

When this embodiment is used to prepare posterior teeth or anterior teeth requiring less transparency, the first colorant 311 contained in the first spraying unit 31 of the colorant-spraying module 3 only contains a warm color solution as in the previous embodiment. However, the second colorant 321 in the second spraying unit 32 is a mixture of a cold color solution, an aluminous solution, a calcareous solution, and a light-transmitting solution. The mixing volume ratio of these four solutions is 1:1:1:1 but not limited. The mixing volume ratio of the four solutions can be adjusted in the range of 1:1:1:1 to 1:1:1:2 according to the situation.

In addition, in other variant implementations, the colorant set can also be configured in a manner opposite to that of the previous embodiment in response to tooth color requirements of different patients. For example, in the first colorant 311, the warm color solution and the light-transmitting solution are mixed in the ratio range of 1:0.1 to 1:1 while in the second colorant 321, the cold color solution, the aluminous solution, and the calcareous solution are simply mixed in the ratio of 1:1:1.

On the other hand, when this embodiment is used to prepare anterior teeth, dental veneers, or posterior teeth requiring higher light transmittance, the first colorant 311 contained in the first spraying unit 31 of the colorant-spraying module 3 includes not only the warm color solution, but also the light-transmitting solution, wherein the mixing volume ratio of these two solutions can be adjusted within the range of 1:0.1 to 1:1 according to the situation. Moreover, the second colorant 321 in the second spraying unit 32 is the same as the above, in which the cold color solution, the aluminous solution, the calcareous solution, and the light-transmitting solution are mixed. Similarly, the mixing volume ratio of these four solutions can be adjusted within the range of 1:1:1:1 to 1:1:1:2 according to the situation. That is to say, both the warm color solution and the cold color solution are mixed with the light-transmitting solution in this embodiment, so a ceramic denture with high light transmittance can be obtained.

Regarding the way to spray the first colorant 311 and the second colorant 321 in this embodiment, as mentioned in the previous embodiment, from the neck to the middle position, the first colorant 311 is mainly used, and its amount is gradually decreased, while from the middle position to the incisal edge, the second colorant 321 is mainly used, and its amount is gradually increased, as the forming is performed from the neck to the incisal edge.

In accordance with the above, the present invention combines the DLP (digital light processing) three-dimensional lamination technology and the inkjet coloring technology, and uses a unique colorant formula to color each slurry layer, including all the component elements of natural tooth color such as cool color, warm color, and light transmittance, so regardless of color or light transmittance, it can present a quite natural gradient color system, which is almost the same as that of natural teeth. Moreover, the present invention can carry out customized production, that is, in the same production batch, dentures for different parts of different patients can be produced at the same time, and personalized fine patterns can even be drawn. Furthermore, since the thickness of each slurry layer can be set to 10 μm to 50 μm, and multiple drying technologies including the substrate with high water absorption, the airflow-generating device for drying the substrate, and the heating device for heating and drying the slurry are added, the slurry and the colorants are allowed to dry quickly, and the overall process efficiency is excellent.

The above embodiments are only exemplified for the convenience of description, and the scope of rights claimed by the present invention should be subject to the claims and not limited to the above embodiments.

1. A colorant set for a ceramic denture with adjustable light transmittance and color, said colorant set comprising:
a first colorant, including a warm color solution; and
a second colorant, including a cold color solution;
wherein the colorant set for a ceramic denture further includes a light-transmitting solution in one of the following aspects (i)-(iii):
(i) the light-transmitting solution mixed with the first colorant with a ratio of the warm color solution: the light-transmitting solution=1:0.1 to 1:1;
(ii) the light-transmitting solution mixed with the second colorant with a ratio of the cold color solution: the light-transmitting solution =1:1 to 1:2; and
(iii) the light-transmitting solution being a component of a third colorant;
wherein the warm color solution includes 0.1 wt % to 5 wt % of water-soluble iron salt and water; the cold color solution includes 0.01 wt % to 2 wt % of water-soluble cobalt salt and water; the light-transmitting solution includes 10 wt % to 50 wt % of water-soluble yttrium or lanthanum salt and water.

2. The colorant set for a ceramic denture according to claim 1, wherein in the aspect (ii), the second colorant further includes an aluminous solution containing 0.1 wt % to 10 wt % of water-soluble aluminum salt and a calcareous solution containing 0.1 wt % to 10 wt % of water-soluble calcium salt, wherein a ratio of the cold color solution:the light-transmitting solution:the aluminous solution:the calcareous solution=1:1:1:1.

3. The colorant set for a ceramic denture according to claim 2, wherein the water-soluble iron salt in the warm color solution includes at least one of ferric nitrate, ferrous chloride, and ferric acetate; the water-soluble cobalt salt in the cold color solution includes at least one of cobaltic nitrate, cobaltous chloride, and cobaltic acetate; the water-soluble aluminum salt in the aluminous solution includes at least one of aluminum nitrate, aluminum chloride, and aluminum acetate; the water-soluble calcium salt in the calcareous solution includes at least one of calcium nitrate, calcium chloride, and calcium acetate.

4. A three-dimensional lamination apparatus, comprising:
a slurry-laying module, including a slurry tank, in which a slurry is stored;
a colorant-spraying module, including the colorant set for a ceramic denture according to claim 1;
a photocuring module; and
a main controller, electrically connected to the slurry-laying module, the colorant-spraying module and the photocuring module, the main controller including a memory module, in which a plurality of laminated graphic files and a plurality of coloring parameter files are stored, the plurality of laminated graphic files being obtained by slicing a three-dimensional image of a dental crown to be formed in a specific direction at a specific thickness, and the plurality of coloring parameter files corresponding to the plurality of laminated graphic files;
wherein the main controller controls the slurry-laying module to lay a slurry layer on a substrate with the slurry in the slurry tank; the main controller controls the colorant-spraying module according to the plurality of coloring parameter files to spray the colorant on the slurry layer with the colorant set for a ceramic denture; the main controller controls the photocuring module to photocure the slurry layer according to the plurality of laminated graphic files.

5. A three-dimensional lamination apparatus, comprising:
a slurry-laying module, including a slurry tank, in which a slurry is stored;
a colorant-spraying module, including the colorant set for a ceramic denture according to claim 2;
a photocuring module; and
a main controller, electrically connected to the slurry-laying module, the colorant-spraying module and the photocuring module, the main controller including a memory module, in which a plurality of laminated graphic files and a plurality of coloring parameter files are stored, the plurality of laminated graphic files being obtained by slicing a three-dimensional image of a dental crown to be formed in a specific direction at a specific thickness, and the plurality of coloring parameter files corresponding to the plurality of laminated graphic files;
wherein the main controller controls the slurry-laying module to lay a slurry layer on a substrate with the slurry in the slurry tank; the main controller controls the colorant-spraying module according to the plurality of coloring parameter files to spray the colorant on the slurry layer with the colorant set for a ceramic denture; the main controller controls the photocuring module to photocure the slurry layer according to the plurality of laminated graphic files.

6. A three-dimensional lamination apparatus, comprising:
a slurry-laying module, including a slurry tank, in which a slurry is stored;
a colorant-spraying module, including the colorant set for a ceramic denture according to claim 3;
a photocuring module; and
a main controller, electrically connected to the slurry-laying module, the colorant-spraying module and the photocuring module, the main controller including a memory module, in which a plurality of laminated graphic files and a plurality of coloring parameter files are stored, the plurality of laminated graphic files being obtained by slicing a three-dimensional image of a dental crown to be formed in a specific direction at a specific thickness, and the plurality of coloring parameter files corresponding to the plurality of laminated graphic files;
wherein the main controller controls the slurry-laying module to lay a slurry layer on a substrate with the slurry in the slurry tank; the main controller controls the colorant-spraying module according to the plurality of coloring parameter files to spray the colorant on the slurry layer with the colorant set for a ceramic denture; the main controller controls the photocuring module to photocure the slurry layer according to the plurality of laminated graphic files.

7. The three-dimensional lamination apparatus according to claim 4, wherein the colorant-spraying module includes a first spraying unit, a second spraying unit, and a third spraying unit; the colorant set for a ceramic denture includes the light-transmitting solution in the aspect (iii); the first spraying unit contains the first colorant, the second spraying unit contains the second colorant, and the third spraying unit contains the light-transmitting solution.

8. The three-dimensional lamination apparatus according to claim 4, wherein the colorant-spraying module includes a first spraying unit and a second spraying unit; the colorant set for a ceramic denture includes the light-transmitting solution in at least one of the aspect (i) and the aspect (ii); the first spraying unit contains the first colorant, and the second spraying unit contains the second colorant.

9. The three-dimensional lamination apparatus according to claim 4, wherein the slurry includes 100 parts by weight of ceramic powder, 12-18 parts by weight of photocurable resin, 2-4 parts by weight of plasticizer, 0.5-5 parts by weight of dispersant and 10-20 parts by weight of a solvent, which includes water.

10. The three-dimensional lamination apparatus according to claim 9, wherein the ceramic powder includes more than 99.7% mixed powder containing zirconium oxide powder and yttrium oxide powder, less than 0.1% aluminum oxide powder, and less than 0.05% base color colorant; the content of the yttrium oxide powder in the mixed powder is 2-6 mole %; the base color colorant includes at least one of iron, chromium, titanium, manganese, cobalt, nickel, copper, vanadium, and rare earth elements.

11. The three-dimensional lamination apparatus according to claim 4, further comprising an airflow-generating device, which is electrically connected to the main controller, wherein the substrate is composed of a material or structure with a water absorption rate of 5% or more; the main controller controls the airflow-generating device to blow air toward the lower surface of the substrate or draw air from the lower surface of the substrate.

12. The three-dimensional lamination apparatus according to claim 4, further comprising a heating device, which is electrically connected to the main controller, wherein the main controller controls the heating device to heat the slurry layer.
